(19) United States
(12) Patent Application Publication
(10) Pub. No.: US 2010/0158125 A1
(43) Pub. Date: Jun. 24, 2010

(54) METHOD AND APPARATUS FOR CONSTRUCTING AND DECODING VIDEO FRAME IN VIDEO SIGNAL PROCESSING APPARATUS USING MULTI-CORE PROCESSING

(75) Inventors: Young-O PARK, Yongin-si (KR); Kwang-Pyo Choi, Anyang-si (KR); Yong-Serk Kim, Seoul (KR); Young-Hun Joo, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/643,164

(22) Filed: Dec. 21, 2009

(30) Foreign Application Priority Data
Dec. 19, 2008 (KR) 10-2008-0130721

(51) Int. Cl. H04N 7/26

(52) U.S. Cl. 375/240.16; 375/240.24; 375/E07.2; 375/E07.124

(57) ABSTRACT

A method is provided for constructing a video frame in a video signal processing apparatus using multi-core processing, in which multiple macro blocks are generated from a video signal on a predetermined unit basis, and a video frame is constructed by combining the generated multiple macro blocks with header information. The video frame includes one correlation information field for recording information about correlations between the multiple macro blocks, and the one correlation information field is located in front of the multiple macro blocks constituting the video frame.

### PRIORITY

This application claims the benefit of a Korean Patent Application filed in the Korean Intellectual Property Office on Dec. 19, 2008 and assigned Serial No. 10-2008-0130721, the entire disclosure of which is hereby incorporated by reference.

### BACKGROUND

1. Field

The present exemplary embodiments relate to a method and apparatus for constructing a video frame and decoding the video frame in a video signal processing apparatus using multi-core processing.

2. Description of the Related Art

Generally, an apparatus capable of replaying multimedia data (hereinafter referred to as a “video signal processing apparatus”) uses a video signal compression scheme (or a video codec) for compressing a video signal, in replaying moving images. Coding standards for the video signal compression scheme include MPEG-4, H.264, H.263, VC1, etc.

The video signal processing apparatus normally includes a Central Processing Unit (CPU) for video signal processing. The CPU has been changing from a single-core CPU to a multi-core CPU mainly in the Personal Computer (PC) market. For example, a CPU supporting a multi-core scheme in a PC includes Core 2 Duo and Quad Core by Intel, Dual-Core Opteron by AMD, Power4 by IBM, etc.

Such a trend exists even in the field of processors of mobile devices capable of video signal processing. For example, a processor supporting the multi-core scheme in a mobile device may include Cortex-A9 MP Core by ARM.

FIG. 1 shows a structure of a video frame proposed in MPEG-4, one of conventional video signal compression schemes.

Referring to FIG. 1, a video frame includes a Video Object Plane (VOP) Header field 100 and a Macro Block (MB) field. The MB field has a structure in which multiple, i.e., a plurality of, MBs 110 and 120 are combined.

Each of the multiple MBs includes an MB Header field 122 and an MB Data field 126. The MB Header field 122 has a Motion Vector Difference (MVD) 124 in it. In other words, the MVD exists in every MB. The MVD is information defining correlated MBs, which is required for efficient compression in a process of encoding and decoding a video signal.

In an ordinary video signal compression scheme, information about neighboring MBs is used in en encoding process to increase a compression efficiency of a video signal. For example, in MPEG-4, MVD is defined as information about neighboring MBs.

Therefore, in a decoding process, decoding is performed using the information about neighboring MBs (or correlated MBs). That is, in case of MPEG-4, the MVD or the information about neighboring MBs should be previously acquired in order to decode a certain MB.

FIG. 2 shows a process of decoding a video signal in a conventional video signal processing apparatus using multi-core processing.

In FIG. 2, the entire tetragon represents one frame (hereinafter referred to as a “screen frame”), and small tetragons forming the screen frame represent MBs.

Therefore, the screen frame shown in FIG. 2 includes 20 MBs. It is assumed that MBs existing in different rows constituting the screen frame are decoded by different cores. That is, a first core Core1 performs decoding on a 1^{st} MB to a 5^{th} MB existing in a first row, and a second core Core2 performs decoding on a 6^{th} MB to a 10^{th} MB existing in a second row. A third core Core3 performs decoding on an 11^{th} MB to a 15^{th} MB existing in a third row, and a fourth core Core4 performs decoding on a 16^{th} MB to a 20^{th} MB existing in a fourth row.

As described above, however, information about neighboring MBs should be used to decode a certain MB. In other words, in order to decode a certain MB, decoding on neighboring MBs should be carried out.

For example, in order to decode an 8^{th} MB, decoding on 3^{rd}, 4^{th} and 7^{th} MBs, which are neighboring MBs, should be completed. That is, unless the first core completes decoding on the 4^{th} MB, the second core cannot start decoding on the 8^{th} MB. The third and fourth cores also cannot commence decoding on MBs assigned thereto until decoding on correlated MBs is completed.

Therefore, in accordance with the conventional video signal compression scheme, even though all cores simultaneously begin decoding on MBs assigned thereto, each core may not perform decoding according to sequence of the assigned MBs and should wait for completion of decoding on the correlated MBs.

When a video signal compression scheme that does not consider the correlations between MBs is adopted to resolve the above problems, compression efficiency of video signals may be deteriorated, causing another problem.

### SUMMARY

An aspect of an exemplary embodiment is to address at least the above-mentioned problems and/or disadvantages and to provide at least the advantages described below. Accordingly, an aspect of an exemplary embodiment provides a method for defining a structure of a video frame to facilitate efficient parallel processing for decoding of a video signal in a video signal processing apparatus using multi-core processing, and for constructing the video frame.

Another aspect of an exemplary embodiment provides a decoding method for allowing multiple cores to simultaneously perform video signal decoding in a video signal processing apparatus using multi-core processing.

A further another aspect of an exemplary embodiment provides a video signal processing apparatus using multi-core processing, for encoding a video signal to facilitate efficient multi-core based parallel processing and decoding the encoded video signal.

In accordance with one aspect of an exemplary embodiment, there is provided a method for constructing a video frame in a video signal processing apparatus using multi-core processing, in which multiple, i.e., a plurality of, macro blocks are generated from a video signal on a predetermined unit basis, and a video frame is constructed by combining the generated multiple macro blocks with header information. The video frame includes one correlation information field for recording information about correlations between the multiple macro blocks, and the one correlation information field is located in front of the multiple macro blocks constituting the video frame.

In accordance with another aspect of an exemplary embodiment, there is provided a method for decoding a video frame in a video signal processing apparatus using multi-core processing, in which correlation information recorded in one correlation information field existing in the video frame is decoded, and each of multiple cores for supporting the multi-core processing decodes at least one macro block assigned thereto among multiple macro blocks existing in the video frame based on the decoded correlation information. The correlation information is information about correlations between the multiple macro blocks, and the one correlation information field is located in front of a field in which the multiple macro blocks are recorded.

In accordance with further another aspect of an exemplary embodiment, there is provided a video signal processing apparatus using multi-core processing, in which an encoder generates multiple macro blocks from a video signal on a predetermined unit basis, and constructs a video frame by combining the generated multiple macro blocks with header information and information about correlations between the multiple macro blocks, and a decoder decodes the information about correlations between the multiple macro blocks existing in the video frame, and decodes at least one macro block assigned thereto among the multiple macro blocks existing in the video frame based on the decoded correlation information. The correlation information is located in front of the multiple macro blocks, and the decoder is provided for each of multiple cores for supporting the multi-core processing.

In accordance with yet another aspect of an exemplary embodiment, there is a method for decoding a video frame in a video signal using multi-core central processing unit (CPU), the method including: extracting a plurality of correlation information for a plurality of macro blocks in a first field of a video frame; first decoding by one core of the multi-core CPU, a first macro block of the plurality of macro blocks, based on a first one of the extracted plurality of correlation information; and second decoding by another core of the multi-core CPU, a second macro block of the plurality of macro blocks, based on a second one of the extracted plurality of correlation information, wherein the first decoding is performed substantially simultaneously with the second decoding.

### BRIEF DESCRIPTION OF THE DRAWINGS

The above and other aspects, features and advantages of certain exemplary embodiments will be more apparent from the following description taken in conjunction with the accompanying drawings, in which:

FIG. 1 is a diagram showing a structure of a video frame proposed in MPEG-4, one of conventional video signal compression schemes;

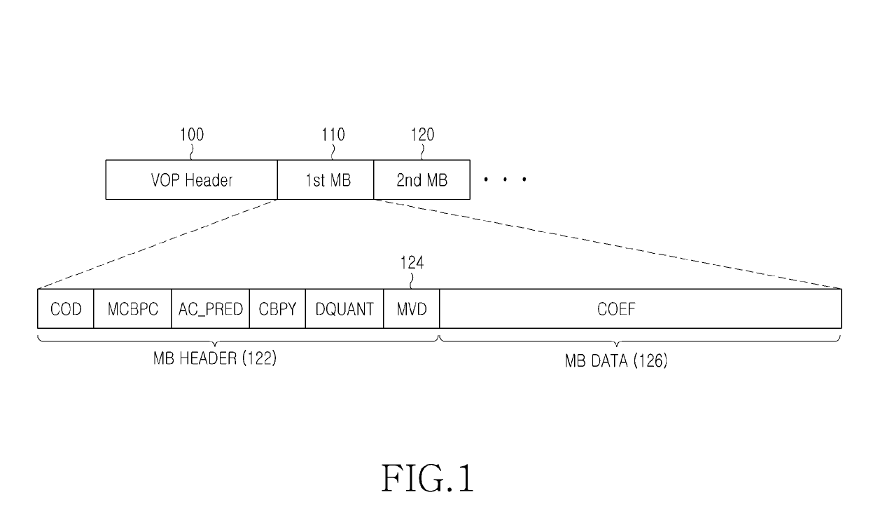

FIG. 2 is a diagram showing a process of decoding a video signal in a conventional video signal processing apparatus using multi-core processing;

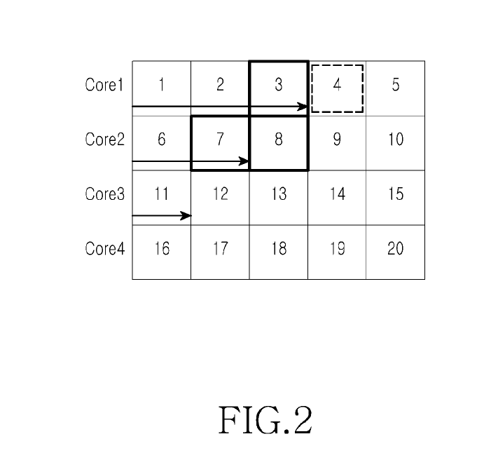

FIG. 3 is a diagram showing a structure of a video frame according to an exemplary embodiment;

FIGS. 4A to 4D are diagrams showing exemplary structures of an MB position information field in a video frame proposed according to an exemplary embodiment;

FIG. 5 is a diagram showing an operation of decoding a video frame on the time axis according to an exemplary embodiment;

FIG. 6 is a diagram showing a decoding process for displaying one screen frame by one video frame according to an exemplary embodiment; and

FIG. 7 is a diagram showing an example of a multi-core processor using multi-core processing, to which an exemplary embodiment is to be applied, which has two cores.

Throughout the drawings, the same drawing reference numerals will be understood to refer to the same elements, features and structures.

### DETAILED DESCRIPTION OF EXEMPLARY EMBODIMENTS

The terms and words used in the following description and claims are not limited to the bibliographical meanings, but, are merely used by the inventor to enable a clear and consistent understanding of the exemplary embodiments. Accordingly, it should be apparent to those skilled in the art that the following description of exemplary embodiments are provided for illustration purpose only and not for the purpose of limiting the exemplary embodiments as defined by the appended claims and their equivalents.

In the exemplary embodiments described below, MVDs existing in the conventional MBs are combined into one-MVD information, and the combined MVD information is recorded in a field in a video frame (hereinafter referred to as a “correlation information field”). Therefore, by decoding the MVD information recorded in the one correlation information field, it is possible to undertake decoding on a particular MB regardless of the completion of decoding on MBs correlated to the particular MB.

In addition, a field for recording information about a position of each of MBs in a video frame (hereinafter referred to as an “MB position information field”) is defined in the video frame. Therefore, based on information about a position of each of MBs recorded in the MB position information field, each of the cores may find out a start position of MBs it will decode.

For the foregoing description, a definition should be given of a structure of a video frame with a correlation information field and an MB position information field, which is described by the exemplary embodiments.

Also, a plan to generate a video frame with the described structure and another plan to decode a video signal based on the video frame with the described structure should be prepared. In addition, a detailed description should be made of a video signal processing apparatus using multi-core processing, for encoding or decoding a video signal based on the video frame with the described structure.

Exemplary embodiments will be described in detail below with reference to the accompanying drawings.

A. Structure of Video Frame

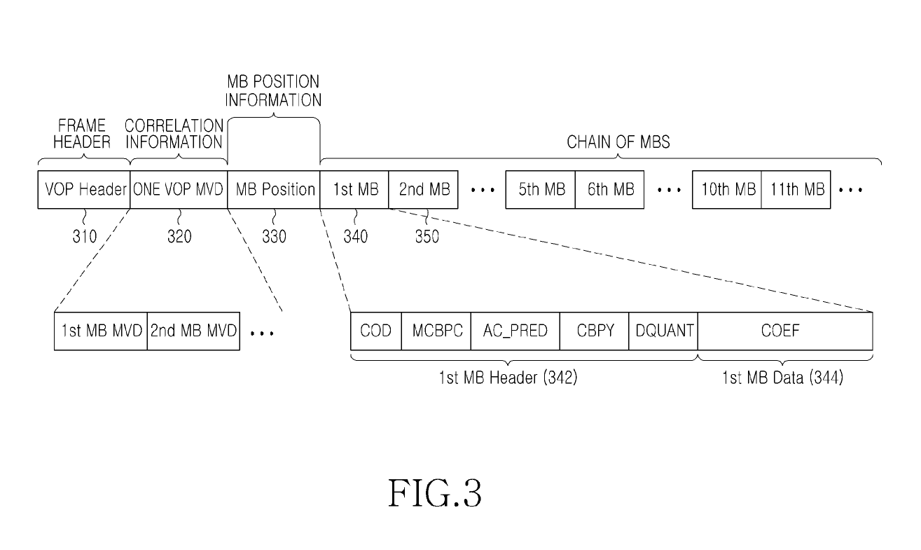

FIG. 3 shows a structure of a video frame according to an exemplary embodiment.

Referring to FIG. 3, a structure of a video frame starts with a VOP Header 310 and includes one correlation information field (hereinafter referred to as “ONE VOP MVD”) 320 located in front of a chain of MBs 340, 350, . . . , etc. Optionally, the video frame includes one MB position information field (hereinafter referred to as “MB Position”) 330. The ONE VOP MVD 320 and the MB Position 330 are replaceable with each other. However, it is preferable, but not necessary, that the VOP MVD 320 and the MB Position 330 are located in front of a chain of MBs 340, 350, . . . , etc.

In the VOP Header 310, Video Object Plane (VOP) is a concept corresponding to a video frame in MPEG-4. The VOP Header 310 is placed in a start portion of the video frame and includes a frame parameter.

Each of MBs 340 and 350 has a MB Header 342 and a MB Data 344. The MB Header 342 has no MVD, unlike the MB Header 122 in the conventional video frame.

The ONE VOP MVD 320 includes specific information about correlations of each of all MBs constituting one frame. That is, the specific information is information defining correlations with neighboring MBs that should be considered when decoding each of all MBs constituting one frame. Therefore, the specific information will be defined in association with each of the MBs.

Aside from MVD, the specific information may include intra prediction mode information, a picture order count (POC) value, and/or a coded block pattern (cbp) value of H.264, that can be used for efficient video compression. However, it is to be noted that the specific information is specified to MVD in exemplary embodiments.

As described above, the ONE VOP MVD 320 is described in the exemplary embodiment. However, unlike the conventional video frame, the video frame described by the exemplary embodiments prevents an MB Header constituting each MB of the video frame from including MVD, avoiding a change in the total size of the video frame. Therefore, defining the ONE VOP MVD 320 in the video frame will not cause a reduction in compression efficiency of a video signal.

The MB Position 330 includes position information of MBs in the video frame. The “position information” may be a start byte position of a relevant MB.

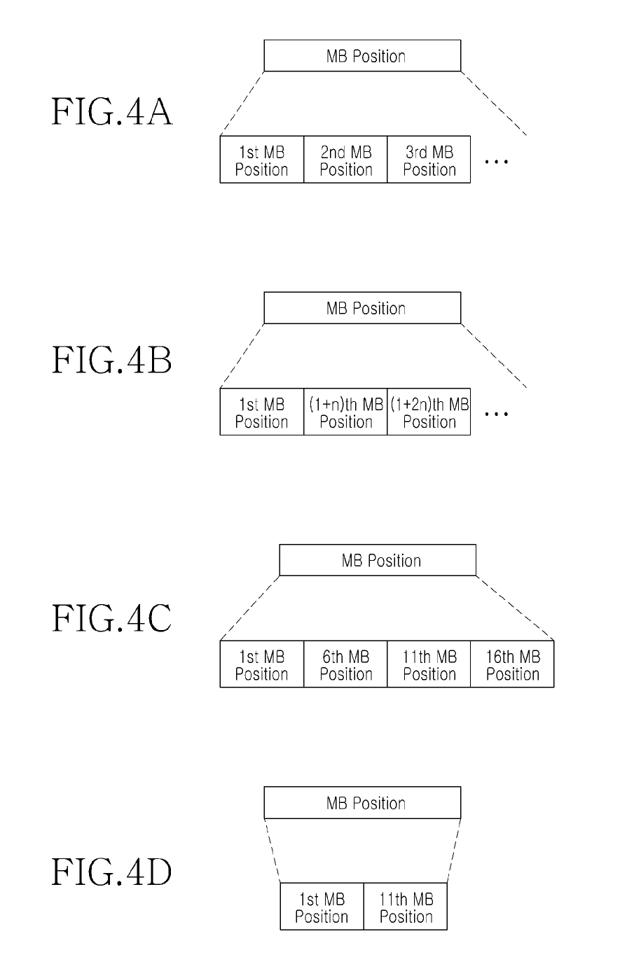

FIGS. 4A to 4D show exemplary structures of an MB position information field (MB Position) in a video frame.

As shown in FIG. 4A, the MB Position 330 may include position information of all MBs constituting one frame.

As another example, as shown in FIG. 4B, the MB Position 330 may be adapted to include, not the position information of all MBs, but only the start position information of a first MB among the MBs assigned to each core for decoding. The number of MBs assigned to each of the cores may be equal or different.

If the same number of MBs are assigned to each core, the start position information may be determined based on a predetermined interval ‘n’. The predetermined interval ‘n’ may be determined by a quotient obtained by dividing the total number of MBs by the number ‘m’ of cores. That is, the predetermined interval ‘n’ will be defined as the number of MBs assigned to each core. In this case, positions of MBs in which start position information is recorded are 1, 1+n, 1+2n, 1+3n, . . . .

It is preferable, but not necessary, to apply FIG. 4B to a case where the total number of MBs is a multiple of the number of cores. However, even when the total number of MBs is not a multiple of the number of cores, a different number of MBs may be assigned to at least one of the cores.

For example, FIG. 4C shows a case in which a multi-core processor with 4 cores decodes a total of 20 MBs. In this case, the MB Position 330 may include positions of only 1^{st}, 6^{th}, 11^{th} and 16^{th} MBs.

Also, FIG. 4D shows a case in which a multi-core processor with 2 cores decodes a total of 20 MBs. In this case, the MB Position 330 may include positions of only 1^{st} and 11^{th} MBs. Such a criterion is subject to change according to multi-core processing selected by those skilled in the art.

Meanwhile, the MB Position 330 is a field that is not included in a structure of the conventional video frame, and this is a portion that is added in the video frame. The MB position information recorded in the MB Position 330 occupies a small portion of the video frame, compared to the MB Header. That is, given the advantages due to a low ratio (normally, some 10% or 20%) occupied by the MB Header part in one MB and to the efficient multi-processing, the increment corresponding to the position information is negligible, exerting almost no influence on compression efficiency of the video frame.

In the foregoing description, regarding the proposed video frame, the regions, in which different information is recorded, are called “fields” for convenience's sake. However, the video frame may be expressed as one bit stream. That is, one video frame may be defined as one bit stream created by concatenating bits of information recorded in respective fields shown in FIG. 3.

To construct the above-described video frame, a video signal processing apparatus using multi-core processing generates multiple MBs from a video signal to be compressed, on a predetermined unit basis. The predetermined unit is the minimum unit for compressing or decoding a video signal in an MB.

The video signal processing apparatus constructs one video frame by combining the generated multiple MBs, and additionally combining header information and information about correlations between the MBs in front of the combined MBs.

A video signal compressed by the multiple MBs constituting one video frame is a video signal capable of forming one screen frame. As stated above, the information about correlations between MBs is defined in association with each of the MBs.

To construct the one video frame, the video signal processing apparatus additionally combines information about a start position of the multiple MBs in front of the combined MBs. The start position information should include at least information about a start position of MBs on which each core will perform decoding in a decoding process.

B. Decoding on Video Signal

Decoding on a video frame starts with decoding correlation information in the video frame. That is, the video signal processing apparatus using multi-core processing decodes correlation information recorded in one correlation information field (or ONE VOP MVD) existing in a video frame. It is obvious to those skilled in the art that decoding a frame header in the video frame should be performed among others.

Each of multiple cores provided in the video signal processing apparatus using multi-core processing decodes at least one MB assigned thereto among the multiple MBs existing in the video frame based on the decoded correlation information. Preferably, the at least one MB assigned to each of the cores is different from each other.

The correlation information, as described above, is information about correlations between the multiple MBs, and is located in front of a field in which the multiple MBs are recorded.

In addition, the video signal processing apparatus decodes MB position information existing in front of the multiple MBs in the video frame, and each of the cores checks a start point of at least one MB it will decode, based on the decoded MB position information.

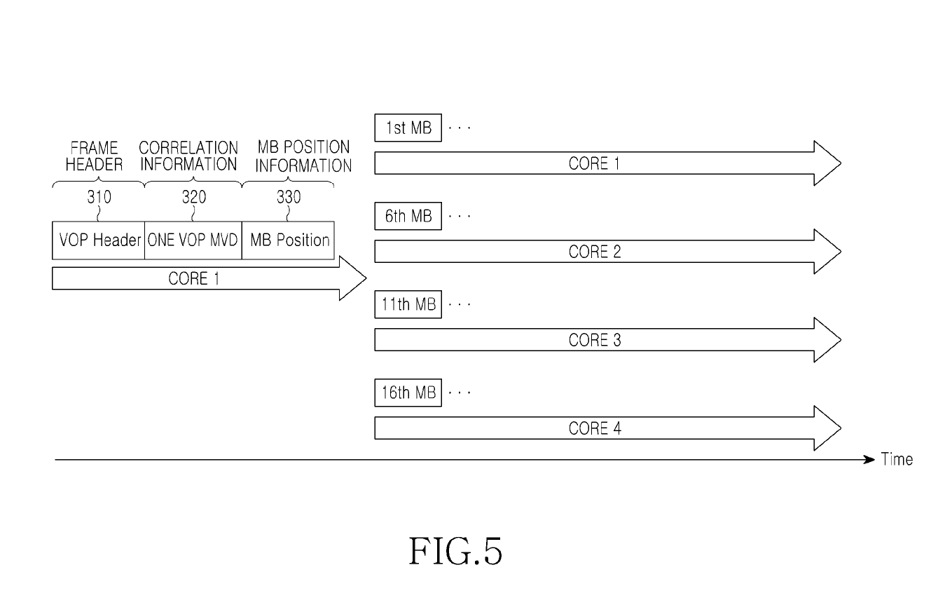

FIG. 5 shows an operation of decoding a video frame on the time axis according to an exemplary embodiment.

Referring to FIG. 5, a certain core (a first core in the drawing) among the multiple cores previously acquires header information and MB correlation information of a video frame by decoding a VOP Header 310 and a ONE VOP MVD 320 including specific information about correlations between all MBs constituting the video frame.

The certain core acquires a start position of MBs that respective cores will decode, by decoding an MB Position 330. Therefore, the respective cores may simultaneously start decoding at MBs in specific positions in the video frame. The specific positions refer to positions of MBs where the cores can start decoding, and different positions may be designated to the respective cores.

For example, assuming that one video frame includes 20 MBs and they are decoded by 4 cores, then a first core, a second core, a third core and a fourth core simultaneously start decoding beginning from a 1^{st} MB, a 6^{th} MB, an 11^{th} MB and an 16^{th} MB, respectively. In decoding MBs assigned thereto, the respective cores refer to correlation information corresponding to their associated MBs in the MB correlation information decoded before.

However, if the start positions cannot be acquired as the video frame does not include the MB Position 330, then the cores may not simultaneously start decoding at MBs in predetermined specific positions in the video frame.

In the foregoing description, it is assumed that the VOP Header 310, the ONE VOP MVD 320 and the MB Position 330 are decoded by any one of multiple cores. However, the decoding may be achieved by each of the multiple cores.

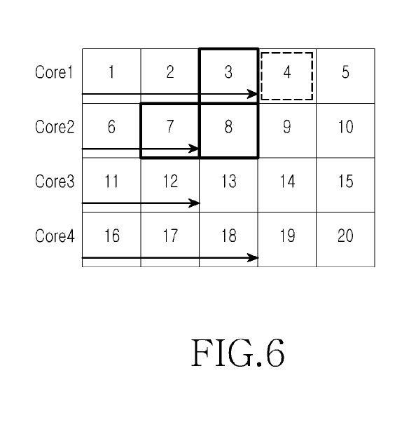

FIG. 6 shows a decoding process for displaying one screen frame by one video frame according to an exemplary embodiment.

It is assumed herein that one screen frame is expressed by 20 MBs and they are decoded by 4 cores. It is also assumed that decoding on a VOP Header, a ONE VOP MVD, and a MB Position constituting a video frame has been completed.

Referring to FIG. 6, a 1^{st} MB to a 5^{th} MB are assigned to a first core, a 6^{th} MB to a 10^{th} MB are assigned to a second core, an 11^{th} MB to a 15^{th} MB are assigned to a third core, and a 16^{th} MB to a 20^{th} MB are assigned to a fourth core.

Therefore, each of the first to fourth cores acquires start position information and correlation information corresponding to MBs assigned thereto. That is, the first core acquires a start position of the 1^{st} MB and correlation information required to decode the 1^{st} MB to the 5^{th} MB, and the second core acquires a start position of the 6^{th} MB and correlation information required to decode the 6^{th} MB to the 10^{th} MB. The third core acquires a start position of the 11^{th} MB and correlation information required to decode the 11^{th} MB to the 15^{th} MB, and the fourth core acquires a start position of the 16^{th} MB and correlation information required to decode the 16^{th} MB to the 20^{th} MB. For example, the second core, as described above, acquires correlation information (i.e., MVD) of the 3^{rd}, 4^{th} and 7^{th} MBs as correlation information required to decode the 8^{th} MB, and for other MBs, acquires correlation information of neighboring MBs of the other MBs.

Thereafter, each of the cores performs decoding on MBs assigned thereto based on the acquired start position and correlation information.

As described above, since specific information (MVDs) of correlated MBs in a video frame has been previously decoded by any one core and known to other cores, it is not necessary for each core to wait for completion of decoding by other cores. That is, the respective cores simultaneously commence decoding at MBs in their start positions regardless of completion of decoding by other cores. For example, even though the first core has not decoded the 3^{rd} and 4^{th} MBs, the second core may decode the 8^{th} MB.

As a result, dependency between the cores in the decoding process disappears and the waiting is unnecessary, facilitating efficient video signal decoding by parallel processing.

C. Video Signal Processing Apparatus

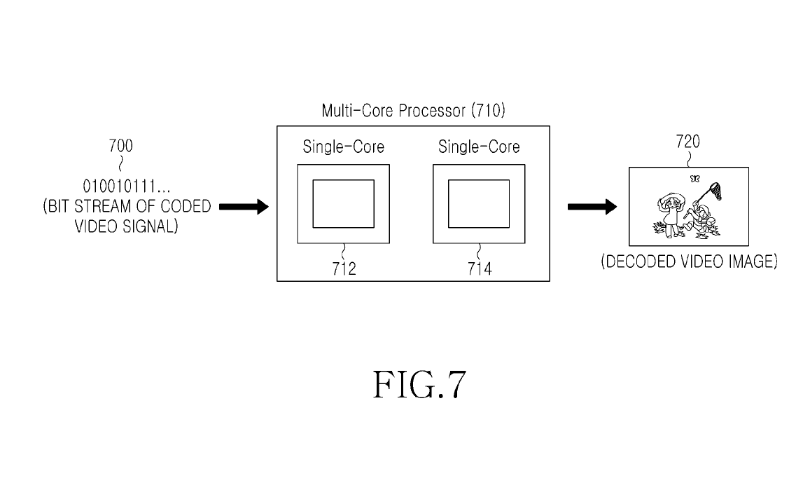

FIG. 7 shows an example of a multi-core processor using multi-core processing, to which an exemplary embodiment is to be applied, which has two cores.

Referring to FIG. 7, a bit stream 700 encoded by a predetermined video signal compression scheme is input to a multi-core processor 710. As described above, the bit stream corresponds to information constituting a video frame.

The bit stream 700 is provided to two cores 712 and 714 constituting the multi-core processor 710. The two cores 712 and 714 decode header information, correlation information and start position information from the bit stream. Each of the two cores 712 and 714 decodes bits in a period corresponding to MBs assigned thereto in the bit stream based on the decoded start position information. For the decoding, each of the two cores 712 and 714 considers the correlation information decoded before.

By decoding the received bit stream 700, the multi-core processor 710 outputs one screen frame 720. The one screen frame 720 may be acquired by one video frame. The one screen frame 720 means one screen (or image) displayed by a display device.

A video signal processing apparatus should be provided to encode and/or decode a video signal based on the video frame of the exemplary embodiment.

A video signal processing apparatus according to an exemplary embodiment includes an encoder for encoding a video signal with a video frame, and a decoder for decoding a video signal based on the video frame. The decoder is provided for each of multiple cores for multi-core processing.

The encoder generates multiple MBs from a video signal on a predetermined unit basis. The encoder constructs a video frame by combining the generated multiple MBs with header information and information about correlations between the multiple MBs.

In constructing a video frame, the encoder additionally combines information about a start position of the multiple MBs. The encoder adds the start position information in front of the multiple MBs in the video frame. The correlation information between the multiple MBs and the start position information are replaceable in the video frame.

The decoder decodes the correlation information between the multiple MBs in the video frame. Further, the decoder decodes at least one MB assigned thereto among the multiple MBs existing in the video frame based on the decoded correlation information.

As the decoder decodes information about a start position of the multiple MBs in the video frame, each of the cores may determine a start position of the MBs it will decode.

As is apparent from the foregoing description, the exemplary embodiments provide a new structure of a video frame generated by compression of a video signal, thereby enabling efficient multi-core processing. In particular, the exemplary embodiments eliminate dependency between cores performing decoding on a video signal, thereby preventing a waiting time from occurring when each core decodes the video signal.

While the exemplary embodiments have been shown and described, it will be understood by those skilled in the art that various changes in form and details may be made therein without departing from the spirit and scope of the exemplary embodiments as defined by the appended claims and their equivalents.

For example, exemplary embodiments have described the case where MPEG-4 is used as a video signal compression scheme. However, it is obvious that the exemplary embodiments may be equally applied to the case where various other video signal compression schemes aside from MPEG-4 are used.

In addition, while the exemplary embodiments consider 4 or 2 cores, the exemplary embodiments may be equally applied to all multi-core processors having multiple cores.

Moreover, the number of MBs constituting one screen frame is subject to various changes. That is, while it has been assumed that one screen frame is displayed by 20 MBs in exemplary embodiments, the exemplary embodiments may be equally applied to all screen frames consisting of different numbers of MBs.

What is claimed is:

1. A method for constructing a video frame in a video signal processing apparatus using multi-core processing, comprising:
generating a plurality of macro blocks from a video signal on a predetermined unit basis; and
constructing a video frame by combining the generated plurality of macro blocks with header information;
wherein the video frame comprises one correlation information field comprising correlation information about correlations of the plurality of macro blocks, and the one correlation information field is located in front of the plurality of macro blocks of the video frame.

2. The method of claim 1, wherein the correlation information is recorded in the one correlation information field, and the correlation information comprises motion vector differences (MVDs) of the plurality of macro blocks.

3. The method of claim 1, wherein the predetermined unit is a minimum unit for compressing the video signal in a macro block, and the plurality of macro blocks of the video frame form a video signal corresponding to one screen frame.

4. The method of claim 1, wherein the video frame further comprises a macro block position information field including information about start positions of the plurality of macro blocks, in front of the plurality of macro blocks.

5. A method for decoding a video frame in a video signal processing apparatus using multi-core processing, comprising:
decoding correlation information in one correlation information field in the video frame; and
decoding, by each of a plurality of cores supporting the multi-core processing, at least one corresponding macro block of a plurality of macro blocks in the video frame, based on the decoded correlation information;
wherein the correlation information comprises information about correlations of the plurality of macro blocks, and the one correlation information field is located in front of a field in which the plurality of macro blocks are recorded.

6. The method of claim 5, wherein correlation information is recorded in the one correlation information field, and the correlation information comprises motion vector differences (MVDs) of the plurality of macro blocks.

7. The method of claim 5, wherein a video signal of the plurality of macro blocks is compressed on a minimum unit basis, and the video signal decoded from the plurality of macro blocks of the video frame is a video signal corresponding to one screen frame.

8. The method of claim 5, further comprising decoding information about start positions of the plurality of macro blocks, recorded in a macro block position information field in front of the plurality of macro blocks in the video frame, wherein each of the plurality of cores checks a start position of at least one corresponding macro block of the plurality of macro blocks, based on the decoded information about the start positions of the plurality of macro blocks.

9. A video signal processing apparatus using multi-core processing, comprising:
an encoder which generates a plurality of macro blocks from a video signal on a predetermined unit basis, and constructs a video frame by combining the generated plurality of macro blocks with header information and correlation information about correlations of the plurality of macro blocks; and
a decoder which decodes the correlation information of the plurality of macro blocks in the video frame, and decodes at least one corresponding macro block of the plurality of macro blocks in the video frame, based on the decoded correlation information;
wherein the correlation information is located in front of the plurality of macro blocks, and the decoder is provided for each of plurality of cores supporting the multi-core processing.

10. The video signal processing apparatus of claim 9, wherein the correlation information is recorded in one correlation information field, and the correlation information comprises motion vector differences (MVDs) of the plurality of macro blocks.

11. The video signal processing apparatus of claim 9, wherein the predetermined unit is a minimum unit for compressing the video signal in a macro block of the plurality of macro blocks, and the video signal decoded from the plurality of macro blocks of one video frame is a video signal corresponding to one screen frame.

12. The video signal processing apparatus of claim 9, wherein the encoder constructs the video frame by additionally combining information about start positions of the plurality of macro blocks in front of the plurality of macro blocks.

13. A method for decoding a video frame in a video signal using multi-core central processing unit (CPU), the method comprising:
extracting a plurality of correlation information for a plurality of macro blocks in a first field of a video frame;
first decoding by one core of the multi-core CPU, a first macro block of the plurality of macro blocks, based on a first one of the extracted plurality of correlation information; and
second decoding by another core of the multi-core CPU, a second macro block of the plurality of macro blocks, based on a second one of the extracted plurality of correlation information,
wherein the first decoding is performed substantially simultaneously with the second decoding.

14. The method of claim 13, wherein the first one of the extracted plurality of correlation information comprises information of correlations of the first macro block with first neighboring macro blocks of the plurality of macro blocks and the second one of the plurality of extracted plurality of correlation information comprises information of correlations of the second macro block with second neighboring macro blocks of the plurality of macro blocks.

15. The method of claim 13, wherein the first macro block is of one row of the plurality of macro blocks and the second macro block is of another row of the plurality of macro blocks.

16. The method of claim 13, further comprising extracting information about start positions for the plurality of macro blocks in the first field of a video frame,
wherein each of the plurality of cores checks a start position of at least one corresponding macro block of the plurality of macro blocks, based on the information about the start positions of the plurality of macro blocks.
